(19) United States
(12) Patent Application Publication
(10) Pub. No.: US 2024/0122794 A1
(43) Pub. Date: Apr. 18, 2024

(54) ACOUSTIC SHOCK WAVE OR PRESSURE PULSE TREATMENT AND METHODS OF USE FOR ANTI-AGING

(71) Applicant: Softwave Tissue Regeneration Technologies, Inc., Kennesaw, GA (US)

(72) Inventor: John F. Warlick, Kennesaw, GA (US)

(21) Appl. No.: 17/964,451

(22) Filed: Oct. 12, 2022

(51) Int. Cl. A61H 23/00; A61H 9/00; A61H 23/02

(52) U.S. Cl. CPC A61H 23/008; A61H 9/0007; A61H 9/0021; A61H 23/0218; A61H 23/0245; A61H 2201/1654; A61H 2205/027; A61H 2205/065; A61H 2205/125

(57) ABSTRACT

A method of treating a reflexology zone to reduce aging using pressure pulses or shock waves has the steps of: placing an applicator head of an acoustic shock wave or pressure pulse generator or source at a reflexology zone; coupling the applicator head directly or indirectly to an exposed surface of the skin near the reflexology zone; and activating the generator or source to emit pressure pulses or acoustic shock waves through the skin to the reflexology zone to reduce, reverse or stop cell senescence or aging and apoptosis.

### FIELD OF THE INVENTION

The present invention relates to an improved treatment method of delivering acoustic shock waves to reflexology zones as a systemic treatment for cell senescence or aging and apoptosis.

### BACKGROUND OF THE INVENTION

Human aging is believed to be the result of cellular aging, in which an increasing proportion of cells reach senescence. All cells experience changes with aging becoming larger and less able to divide and multiply. Many cells lose their ability to function, or they begin to function abnormally. Due to cell and tissue changes, organs also change and lose function slowly over a long period of time.

Aging is a complex process that involves many factors including heredity, environment, culture, diet, exercise and leisure, past illnesses, and many other factors. Other aging theories include claims that aging is caused by injuries from ultraviolet light over time, wear and tear on the body, or byproducts of metabolism, while others believe aging is a predetermined process controlled by genes.

Cell changes associated with aging include atrophy wherein cells of any tissue shrink and lose function; the size, shape or organization of cells becomes abnormal; or tumors are formed.

Telomeres are fragments of DNA at the ends of chromosomes that protect the DNA until they become shortened and no longer protect the DNA causing cells to age and not function properly. Shortened telomeres result from cell replenishment by dividing, stressors, chronic inflammation, diet and lifestyle factors. Many diseases and chronic health conditions are associated with shortened telomeres. It may be possible to regenerate shortened telomeres by turning on an enzyme, telomerase, that helps regulate and lengthen telomeres.

Cellular senescence describes the process that drives cells into a controlled and irreversible cell cycle arrest and is initiated by diverse stress-triggering stimuli. Though halted in their cellular growth, senescent cells maintain high metabolic activity and control various physiological functions, such as counteracting tumor formation. Senescence can induce highly opposing effects, depending on whether it occurs in its transient or chronic form. Transiently active senescence is essential in development, regeneration and acute wound repair. On the contrary, cells that accumulate during chronological aging contribute to chronic senescence, leading to numerous tissue pathologies such as diabetic foot ulcers. Shock waves have been reported to be an effective treatment option for this type of pathologies—including impaired wound healing and excessive scar tissue formation.

The underlying mechanisms to the beneficial effects of shock wave treatment have been investigated thoroughly in the last years. For the first time, the role of shock waves as a modulator of cellular senescence discloses a vital part in anti-aging effects of shock wave treatment, as disclosed herein.

### SUMMARY OF THE INVENTION

A method of treating a reflexology zone to reduce aging using pressure pulses or shock waves has the steps of: placing an applicator head of an acoustic shock wave or pressure pulse generator or source at a reflexology zone; coupling the applicator head directly or indirectly to an exposed surface of the skin near the reflexology zone; and activating the generator or source to emit pressure pulses or acoustic shock waves through the skin to the reflexology zone to reduce, reverse or stop cell senescence or aging and apoptosis. The shock wave or pressure pulse generator can be acoustically coupled to the patient's skin using a coupling gel or liquid.

The method wherein the pressure pulse is an acoustic pulse which includes several cycles of positive and negative pressure and the pressure pulse has an amplitude of the positive part of such a cycle that should be above 0.1 MPa and the time duration of the pressure pulse is from below a microsecond to about a second and the rise times of the positive part of the first pressure cycle are in the range of nanoseconds (ns) up to some milliseconds (ms). The acoustic shock waves are very fast pressure pulses having amplitudes above 0.1 MPa and rise times of the amplitude being below 1000 ns. The duration of the shock wave is typically below 1-3 microseconds (μs) for the positive part of a cycle and typically above some microseconds for the negative part of a cycle.

The method includes subjecting the reflexology zone to convergent, divergent, planar or near planar acoustic shock waves or pressure pulses in the absence of a focal point impinging the reflexology zone stimulating a cellular response in the absence of creating cavitation bubbles evidenced by not experiencing the sensation of hemorrhaging caused by the emitted waves or pulses in cells wherein the cells are positioned within a path of the emitted shock waves or pressure pulses; and away from any localized geometric focal volume or point of the emitted shock waves wherein the emitted shock waves or pressure pulses either have no geometric focal volume or point or have a focal volume or point ahead of the skin or beyond the skin thereby passing the emitted waves or pulses through the skin while avoiding having any localized focal point within the skin, wherein shortened telomeres at ends of chromosomes are lengthened, thereby regenerating the telomeres reversing senescence in cells.

The emitted pressure pulses or shock waves are convergent, divergent, planar or near planar and the pressure pulse shock wave generator or source is based on electro-hydraulic, electromagnetic, piezoceramic or ballistic wave generation having an energy density value ranging as low as 0.00001 mJ/mm² to a high end of below 1.0 mJ/mm², wherein subjecting the cells directly to the acoustic shock waves having a low energy density of less than 1.0 mJ/mm² per shock wave stimulates said reflexology zone wherein the reflexology zone is positioned directly within a path of the emitted pressure pulses or acoustic shock waves in the absence of any focal point or if a focal point exists, the reflexology zone being treated is positioned away from any focal point.

Treating the reflexology zone stimulates by accelerating and increasing cell growth or regeneration or repair. The acoustic shock waves or pressure pulses are directed to one or more reflexology zones of the hands, feet or ears to cause a positive biologic response to treat the cells. The acoustic shock waves or pressure pulses can be directed to an entire surface of one or both hands or feet or ears. The positive biologic response reduces or eliminates systemic or local inflammation and reverses senescence in cells. The positive biologic response also initiates, activates or recruits cells reversing senescence.

Stimulating the one or more reflexology zones or the one or more reflexology zones and the cells causes a stimulation or modulation of adrenergic receptors α and β and one or more of a release of nitric oxide, secretion of digestive enzymes, inflammation reduction, hormonal regulation and peptide recruitment and activation. Stimulating the one or more reflexology zones or the one or more reflexology zones and the cells also causes a release of growth factors including, but not limited to VEGF. Stimulating the one or more reflexology zones or the one or more reflexology zones and the cells also causes new blood vessels to be created increasing vascularization and reversing senescence.

The treatments can be repeated one or more times to treat and reverse the senescence condition. The emitted acoustic shock waves or pressure pulses can be low energy soft waves. The low energy soft waves can have an energy density in the range of 0.01 mJ/mm² to 1.0 mJ/mm². Each subjected reflexology zone can receive between 100 and 100,000 acoustic shock waves or pressure pulses per therapy session. The number of repeated treatments can occur on a schedule over a period of one or more weeks, and treatments can be repeated over time as an anti-aging protocol over longer durations of time between repeated treatments.

The cells can be treated with frequencies in the range of 0.5 Hz up to 15 MHz, preferably within a range of 70 to 150 Hz.

A method of stimulating a cellular substance wherein the cellular substance is a patient having senescent cells or a culture of senescent cells has the steps of: treating the cellular substance; activating an acoustic shock wave generator or source to emit pressure pulses or acoustic shock waves directed toward the substance to impinge the substance with pressure pulses or shock waves having a low energy density in the range of 0.00001 mJ/mm² to 1.0 mJ/mm²; the pressure pulse being an acoustic pulse which includes several cycles of positive and negative pressure, wherein the pressure pulse has an amplitude of the positive part of such a cycle should be above 0.1 MPa and the time duration of the pressure pulse is from below a microsecond to about a second, rise times of the positive part of the first pressure cycle in the range of nano-seconds (ns) up to some milli-seconds (ms), the acoustic shock waves being very fast pressure pulses having amplitudes above 0.1 MPa and rise times of the amplitude being below 100's of ns, the duration of the shock wave is typically below 1-3 micro-seconds (μs) for the positive part of a cycle and typically above some micro-seconds for the negative part of a cycle; and subjecting the cellular substance to convergent, divergent, planar or near planar acoustic shock waves or pressure pulses in the absence of a focal point impinging the substance stimulating a cellular response in the absence of creating cavitation bubbles evidenced by not experiencing the sensation of cellular hemorrhaging caused by the emitted waves or pulses in the substance wherein the cellular substance is positioned within a path of the emitted shock waves or pressure pulses and away from any localized geometric focal volume or point of the emitted shock waves wherein the emitted shock waves or pressure pulses either have no geometric focal volume or point or have a focal volume or point ahead of the cellular substance or beyond the cellular substance thereby passing the emitted waves through the cellular substance while avoiding having any localized focal point within the cellular substance wherein the emitted pressure pulses or shock waves are convergent, divergent, planar or near planar and the pressure pulse shock wave generator or source is based on electro-hydraulic, electromagnetic, piezoceramic or ballistic wave generation having an energy density value ranging as low as 0.00001 mJ/mm² to a high end of below 1.0 mJ/mm². The shock waves stimulate the senescent cells enhancing replication.

### Definitions

“Adrenergic receptor”, the adrenergic receptors or adrenoceptors are a class of G protein-coupled receptors that are targets of many catecholamines like norepinephrine (noradrenaline) and epinephrine (adrenaline) produced by the body, but also many medications like beta blockers, β2 agonists and α2 agonists, which are used to treat high blood pressure and asthma for example. Many cells have these receptors, and the binding of a catecholamine to the receptor will generally stimulate the sympathetic nervous system (SNS). SNS is responsible for the fight-or-flight response, which is triggered for example by exercise or fear causing situations. This response dilates pupils, increases heart rate, mobilizes energy, and diverts blood flow from non-essential organs to skeletal muscle. These effects together tend to increase physical performance momentarily.

“Apoptosis”—the death of cells which occurs as a normal and controlled part of an organism's growth or development. During early development, it eliminates unwanted cells. In adults, apoptosis is used to rid the body of cells that have been damaged beyond repair.

A “curved emitter” is an emitter having a curved reflecting (or focusing) or emitting surface and includes, but is not limited to, emitters having ellipsoidal, parabolic, quasi parabolic (general paraboloid) or spherical reflector/reflecting or emitting elements. Curved emitters having a curved reflecting or focusing element generally produce waves having focused wave fronts, while curved emitters having a curved emitting surfaces generally produce wave having divergent wave fronts.

“Divergent waves” in the context of the present invention are all waves which are not focused and are not plane or nearly plane. Divergent waves also include waves which only seem to have a focus or source from which the waves are transmitted. The wave fronts of divergent waves have divergent characteristics. Divergent waves can be created in many different ways, for example: A focused wave will become divergent once it has passed through the focal point. Spherical waves are also included in this definition of divergent waves and have wave fronts with divergent characteristics.

“Extracorporeal” means occurring or based outside the living body.

A “generalized paraboloid” according to the present invention is also a three-dimensional bowl. In two dimensions (in Cartesian coordinates, x and y) the formula yn=2px [with n being ≠2, but being greater than about 1.2 and smaller than 2, or greater than 2 but smaller than about 2.8]. In a generalized paraboloid, the characteristics of the wave fronts created by electrodes located within the generalized paraboloid may be corrected by the selection of (p (−z,+z)), with z being a measure for the burn down of an electrode, and n, so that phenomena including, but not limited to, burn down of the tip of an electrode (−z,+z) and/or disturbances caused by diffraction at the aperture of the paraboloid are compensated for.

A “paraboloid” according to the present invention is a three-dimensional reflecting bowl. In two dimensions (in Cartesian coordinates, x and y) the formula y2=2px, wherein p/2 is the distance of the focal point of the paraboloid from its apex, defines the paraboloid. Rotation of the two-dimensional figure defined by this formula around its longitudinal axis generates a de facto paraboloid.

“Plane waves” are sometimes also called flat or even waves. Their wave fronts have plane characteristics (also called even or parallel characteristics). The amplitude in a wave front is constant and the “curvature” is flat (that is why these waves are sometimes called flat waves). Plane waves do not have a focus to which their fronts move (focused) or from which the fronts are emitted (divergent). “Nearly plane waves” also do not have a focus to which their fronts move (focused) or from which the fronts are emitted (divergent). The amplitude of their wave fronts (having “nearly plane” characteristics) is approximating the constancy of plain waves. “Nearly plane” waves can be emitted by generators having pressure pulse/shock wave generating elements with flat emitters or curved emitters. Curved emitters may comprise a generalized paraboloid that allows waves having nearly plane characteristics to be emitted.

A “pressure pulse” according to the present invention is an acoustic pulse which includes several cycles of positive and negative pressure. The amplitude of the positive part of such a cycle should be above about 0.1 MPa and its time duration is from below a microsecond to about a second. Rise times of the positive part of the first pressure cycle may be in the range of nanoseconds (ns) up to some milliseconds (ms). Very fast pressure pulses are called shock waves. Shock waves used in medical applications do have amplitudes above 0.1 MPa and rise times of the amplitude can be below 1000 ns, preferably at or below 100 ns. The duration of a shock wave is typically below 1-3 microseconds (μs) for the positive part of a cycle and typically above some microseconds for the negative part of a cycle.

“Reflexology zone” as used herein means an area or pressure point on the feet or hands that are access pathways to every organ, gland, muscle, etc. These pathways between pressure points and other parts of the body are thought to be connected via the nervous system and that a neurological relationship exists between the skin and the internal organs, and that the whole nervous system adjusts to a stimulus. According to reflexology theory, application of pressure to feet, hands, or ears sends a calming message from the peripheral nerves in these extremities to the central nervous system, which in turn signals the body to adjust the tension level. This enhances overall relaxation, removes stress, brings internal organs and their systems into a state of optimum functioning, and increases blood supply which brings additional oxygen and nutrients to cells and enhances waste removal. It positively affects the circulatory, respiratory, endocrine, immune, and neuropeptide systems in the body.

“Senescence” refers to loss of a cell's power of division and growth, also the condition or process of deterioration with age. It can refer to either cellular senescence or to senescence of the whole organism. Senescence is a process in which cells reach permanent growth arrest without the death of cells as the whole cell division process stops. A senescent cell is alive but cannot divide, but also has an active metabolism and secretes signaling molecules to communicate with other cells which can be beneficial, such as during wound healing, or detrimental, in the case of chronic inflammation.

“Shock Wave”: As used herein is defined by Camilo Perez, Hong Chen, and Thomas J. Matula; Center for Industrial and Medical Ultrasound, Applied Physics Laboratory, University of Washington, 1013 NE 40th Street, Seattle, Washington 98105; Maria Karzova and Vera A. Khokhlovab; Department of Acoustics, Faculty of Physics, Moscow State University, Moscow 119991, Russia; (Received 9 Oct. 2012; revised 16 Apr. 2013; accepted 1 May 2013) in their publication, “Acoustic field characterization of the Duolith: Measurements and modeling of a clinical shock wave therapy device”; incorporated by reference herein in its entirety.

“Telomeres” play a central role in cell fate and aging by adjusting the cellular response to stress and growth stimulation on the basis of previous cell divisions and DNA damage. At least a few hundred nucleotides of telomere repeats must “cap” each chromosome end to avoid activation of DNA repair pathways. Repair of critically short or “uncapped” telomeres by telomerase or recombination is limited in most somatic cells and apoptosis or cellular senescence is triggered when too many “uncapped” telomeres accumulate.

Waves/wave fronts described as being “focused” or “having focusing characteristics” means in the context of the present invention that the respective waves or wave fronts are traveling and increase their amplitude in direction of the focal point. Per definition the energy of the wave will be at a maximum in the focal point or, if there is a focal shift in this point, the energy is at a maximum near the geometrical focal point. Both the maximum energy and the maximal pressure amplitude may be used to define the focal point.

### BRIEF DESCRIPTION OF THE DRAWINGS

The invention will be described by way of example and with reference to the accompanying drawings in which:

FIG. 1 is a simplified depiction of a pressure pulse/shock wave (PP/SW) generator with focusing wave characteristics.

FIG. 2 is a simplified depiction of a pressure pulse/shock wave generator with plane wave characteristics.

FIG. 3 is a simplified depiction of a pressure pulse/shock wave generator with divergent wave characteristics.

FIG. 4 is a simplified depiction of a pressure pulse/shock wave generator connected to a control/power supply unit.

FIG. 5 is a graph showing an exemplary ultrasound wave pattern.

FIG. 6 is a graph of an exemplary acoustic shock wave pattern.

FIG. 7 shows the shock wave generator device directed at a reflexology zone on a foot of a patient.

FIG. 8 shows the shock wave generator device directed at a reflexology zone on a hand of a patient.

FIG. 9 shows a schematic view showing general reflexology locations of the foot in the human body.

FIG. 10 shows a schematic view showing general reflexology locations of the hand in the human body.

### DETAILED DESCRIPTION OF THE INVENTION

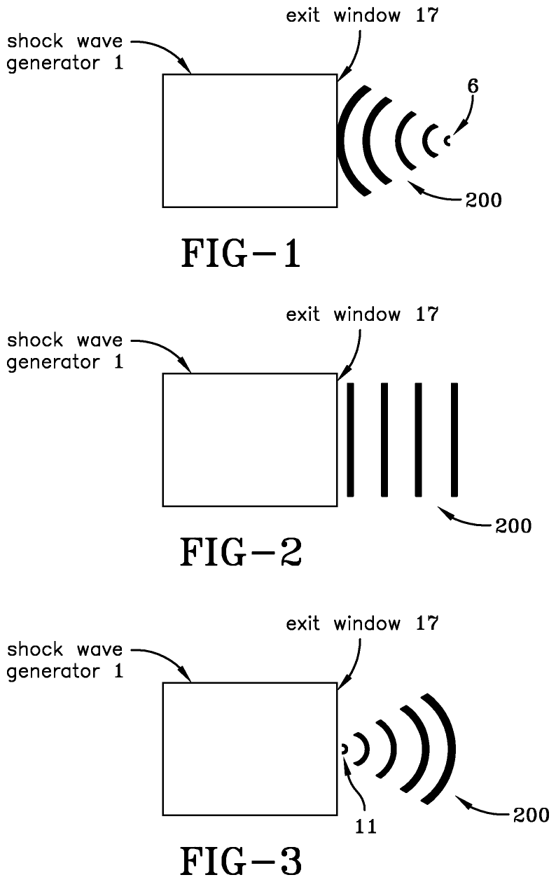

With reference to FIGS. 1-3, a variety of schematic views of acoustic shock waves or pressure pulses are described. The following description of the proper amplitude and pressure pulse intensities of the shock waves are provided along with a description of how the shock waves actually function. For the purpose of describing, the shock waves were used as exemplary and are intended to include all of the wave patterns discussed in the figures as possible treatment patterns.

FIG. 1 is a simplified depiction of a pressure pulse/shock wave (PP/SW) generator, such as a shock wave head, showing focusing characteristics of transmitted acoustic pressure pulses. Numeral 1 indicates the position of a generalized pressure pulse generator, which generates the pressure pulse and, via a focusing element, focuses it outside the housing to treat diseases. The affected tissue or organ is generally located in or near the focal point which is located in or near position 6. At position 17 a water cushion or any other kind of exit window for the acoustical energy is located.

FIG. 2 is a simplified depiction of a pressure pulse/shock wave generator, such as a shock wave head, with plane wave characteristics. Numeral 1 indicates the position of a pressure pulse generator according to the present invention, which generates a pressure pulse which is leaving the housing at the position 17, which may be a water cushion or any other kind of exit window. Somewhat even, also referred to herein as “disturbed”, wave characteristics can be generated, in case a paraboloid is used as a reflecting element, with a point source (e.g. electrode) that is located in the focal point of the paraboloid. The waves will be transmitted into the patient's body via a coupling media such as, e.g., ultrasound gel or oil and their amplitudes will be attenuated with increasing distance from the exit window 17.

FIG. 3 is a simplified depiction of a pressure pulse shock wave generator (shock wave head) with divergent wave characteristics. The divergent wave fronts may be leaving the exit window 17 at point 11 where the amplitude of the wave front is very high. This point 17 could be regarded as the source point for the pressure pulses. The pressure pulse source may be a point source, that is, the pressure pulse may be generated by an electrical discharge of an electrode under water between electrode tips. However, the pressure pulse may also be generated, for example, by an explosion, referred to as a ballistic pressure pulse. The divergent characteristics of the wave front may be a consequence of the mechanical setup.

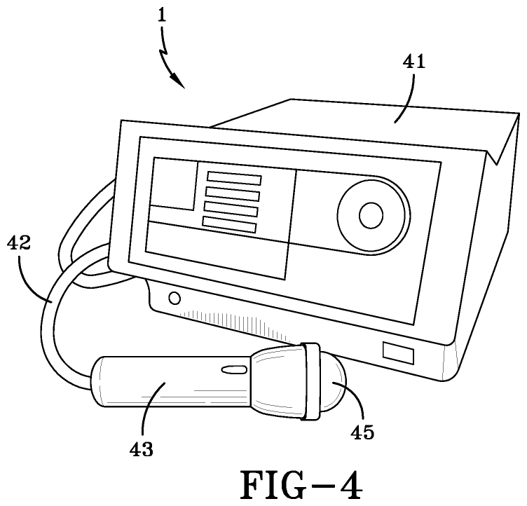

With reference to FIG. 4, an exemplary acoustic shock wave apparatus 1 is illustrated. The shock wave apparatus 1 has a generator 41 connected by a flexible hose with fluid conduits extending from the shock wave generator 41 to an applicator 43 which transmits the acoustic waves when coupled to the skin by using a fluid or acoustic gel. The applicator 43 as illustrated has a body that enables a technician to hold the applicator 43 and as illustrated this applicator is an electrohydraulic that is filled with fluid to facilitate the transmission of the shock waves. The fluid expands a flexible membrane in such a fashion that the membrane extends outwardly in a balloon shape fashion as illustrated in FIG. 4. As shown, this type of applicator 43 has a hydraulic spark generator using either focused or unfocused shock waves, preferably in a low energy level, less than the range of 0.01 mJ/mm² to 0.3 mJ/mm². The flexible hose 42 is connected to a fluid supply that fills the applicator 43 and expands the flexible membrane when filled. Alternatively, a ballistic, piezoelectric or spherical acoustic shock wave device can be used to generate the desired waves.

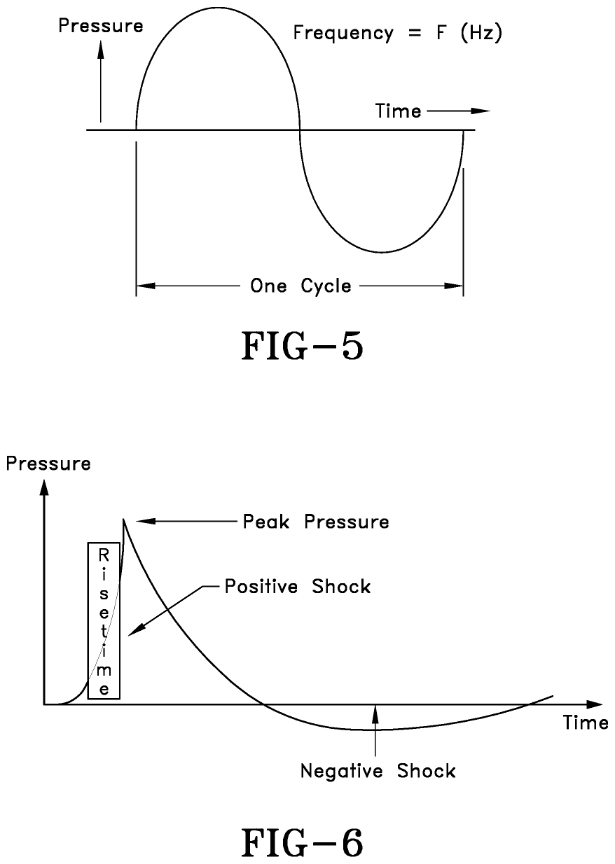

The ultrasonic wave pattern shown in FIG. 5 is contrasted to an asymmetric acoustic wave pattern which is illustrated in FIG. 6. As shown, ultrasound waves are symmetrical having the positive rise time equal to the negative in a sinusoidal wave form. These ultrasound waves generate heat in the tissue and are accordingly believed not suitable for use on cells, organs or brain tissue.

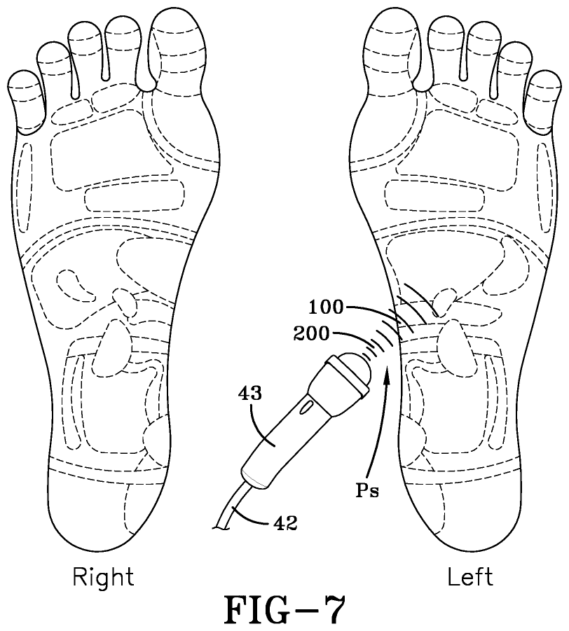

FIG. 7 is a perspective view of a foot of a patient whose reflexology zone or target 100 is being treated. A shock wave applicator head 43 is brought into contact with the skin Ps preferably an acoustic gel is used to enhance the transmission of the shock waves 200 through the skin Ps. The shock wave applicator head 43 can be handheld and manipulated across the skin Ps to drive the shock waves 200 in the direction the shock wave head 43 is pointed to activate a stimulating response through the reflexology zone 100.

As illustrated, the device shown is an electrohydraulic acoustic shock wave generator, however, other devices that generate acoustic shock waves can be used. Ultrasonic devices may be considered, but there is no data to support a sinusoidal wave form would work and therefore not considered as effective as the asymmetric wave generators. The acoustic shock waves activate a cellular response within the reflexology treatment site. This response or stimulation causes an increase of nitric oxide and a release of a variety of growth factors such as VEGF. As shown, the flexible membrane is protruding outward and the applicator 43 has been filled with fluid, the transmission or emission of acoustic shock waves 200 is directed towards the reflexology zone 100. In order to accomplish a good transmission, it is important the flexible membrane be pressed against the patient's skin Ps and as indicated coupling gels may be used. The zone 100, as illustrated, is the reflexology zone for the pancreas which is a region of the foot located in a middle of an inside arch of each foot. By transmitting the shock waves 200 to the zone 100, is it believed that a modulation of the secretions from the pancreas can be made. This modulation or adjustment is achieved by transmitting the acoustic waves 200 at low energy directly onto the zone 100.

The treatment achieves one or more of a) modulating blood sugar levels, b) stimulating insulin production levels or c) normalizing A1C levels. The modulated response is one of an adjustment in blood sugar levels or insulin production and release or normalizing A1C levels which increases low level output, decreases high level output or stabilizes erratic output; It is believed that a single treatment of the zone 100 will achieve the desired modulation. However, repeated treatments may be administered to help maintain and control this secretion level of these hormones. Having achieved a scheduled pattern of treatments, it is possible to achieve regulation of this gland without the use of drugs or other stimulants.

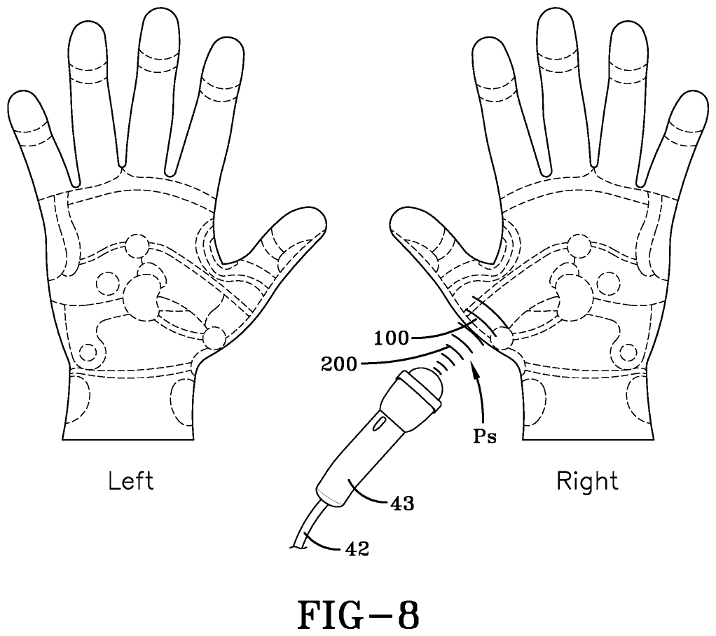

With reference to FIG. 8, a view of a hand of a patient whose reflexology zone 100 is being treated with acoustic shock waves 200 is illustrated. In this illustration, it is important to note that the applicator 43 presses against the skin Ps of the hand in the reflexology zone 100 for the pancreas which is a region of the right hand in the fatty part below the index finger and a region of the left hand below the middle finger close to the wrist.

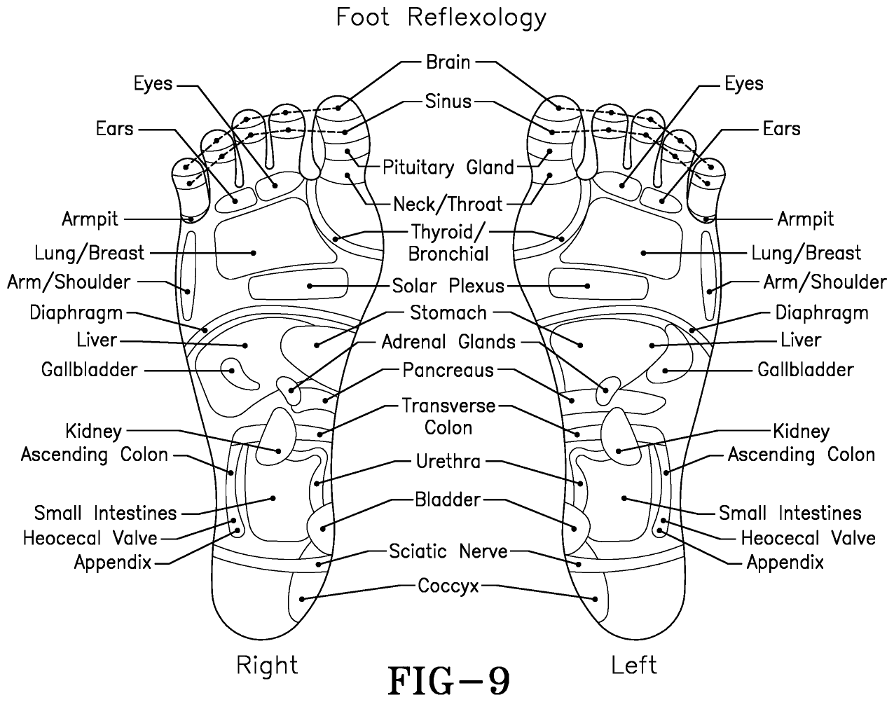

With reference to FIG. 9, a reflexology foot chart is shown detailing the various zones that correspond to organs, glands etc. of the body.

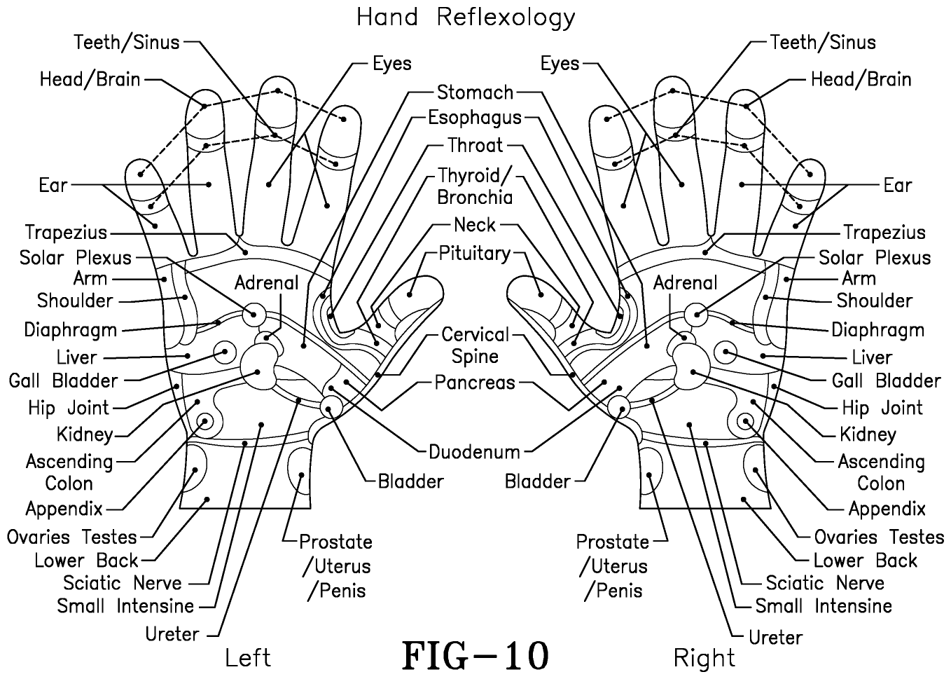

With reference to FIG. 10, a reflexology hand chart is shown detailing the various zones that correspond to organs, glands etc. of the body.

It is believed that modulation and beneficial adjustment can be achieved at reflexology zones for stimulating, modulating or adjusting reflexology zones for glands or organs such as the liver, kidney or any of those indicated in FIG. 9 for the foot zones and FIG. 10 for the hand zones will create a systemic anti-aging response. It is further believed that the hybrid Eastern medical acupuncture treatments or massages historically used are far less effective and less reliable than the results achieved by the deeper tissue penetrating transmission that are achieved by acoustic shock wave therapy applied to these reflexology zones.

The use of shock waves as described above appears to involve factors such as thermal heating, light emission, electromagnetic field exposure, chemical releases in the cells as well as a microbiological response within the cells. Which combination of these factors plays a role in stimulating anti-aging of senescent cells is not yet resolved. However, there appears to be a commonality in the fact that growth factors are released which applicants find indicative that otherwise dormant cells within the tissue appear to be activated which leads to the remarkable ability of the targeted organ or tissue to generate new growth or to regenerate weakened vascular networks in for example the cardiovascular system. Human primary dermal BJ fibroblasts cultured under standard cell culture conditions were driven into either stress-induced premature senescence (SIPS) by doxorubicin treatment of cells with less than 40 population doublings or replicative senescence (achieved by their long-term sub cultivation). Cells were treated in a standardized in vitro set-up using the electrohydraulic DermaGold 100 shock wave device (MTS Medical, Konstanz, Germany). Treatment was performed at different stages of SIPS as well as on cells that were continuously sub cultivated (towards replicative senescence). Onset, progression or changes in cellular senescence were analyzed by monitoring senescence markers such as SA-β-gal activity, γ-H2A.X foci formation or expression of tumor suppressor p53, and cyclin dependent kinase inhibitors p21 and p16 using immunofluorescent/immunohistochemical staining, quantitative real time PCR and Western blot techniques. This finding leads to a complimentary use of shock wave therapy in combination with cell therapies that effectively activate or trigger cells to more rapidly replicate enhancing the ability to harvest and culture more viable cells from the patient, a nutrient culture of said cells, or other sources. The ability to stimulate cells can occur within the patient's own body activating the naturally occurring cells or cells that have been introduced to the patient as part of a treatment beneficially utilizing shock wave treated cells. This is a significant clinical value in its own right.

The substance can be a culture of nutrients having senescent cells, wherein the shock waves stimulate the cells enhancing replications or the human or animal having cells within the patient's body whether naturally occurring or artificially introduced which are activated or otherwise stimulated by the exposure to these shock waves.

This apparatus, in certain embodiments, may be adjusted/modified/or the complete shock wave head or part of it may be exchanged so that the desired and/or optimal acoustic profile such as one having wave fronts with focused, planar, nearly plane, convergent or divergent characteristics can be chosen.

This apparatus may, in certain embodiments, be adjusted/modified/or the complete shock wave head or part of it may be exchanged so that the desired and/or optimal acoustic profile such as one having wave fronts with focused, planar, nearly plane, convergent or divergent characteristics can be chosen.

A change of the wave front characteristics may, for example, be achieved by changing the distance of the exit acoustic window relative to the reflector, by changing the reflector geometry, by introducing certain lenses or by removing elements such as lenses that modify the waves produced by a pressure pulse/shock wave generating element. Exemplary pressure pulse/shock wave sources that can, for example, be exchanged for each other to allow an apparatus to generate waves having different wave front characteristics are described in detail below.

In certain embodiments, the change of the distance of the exit acoustic window can be accomplished by a sliding movement. However, in other embodiments of the present invention, in particular, if mechanical complex arrangements, the movement can be an exchange of mechanical elements.

In one embodiment, mechanical elements that are exchanged to achieve a change in wave front characteristics include the primary pressure pulse generating element, the focusing element, the reflecting element, the housing and the membrane. In another embodiment, the mechanical elements further include a closed fluid volume within the housing in which the pressure pulse is formed and transmitted through the exit window.

In one embodiment, the apparatus of the present invention is used in combination therapy. Here, the characteristics of waves emitted by the apparatus are switched from, for example, focused to divergent or from divergent with lower energy density to divergent with higher energy density. Thus, effects of a pressure pulse treatment can be optimized by using waves having different characteristics and/or energy densities, respectively.

While the above described universal toolbox of the present invention provides versatility, the person skilled in the art will appreciate that apparatuses that only produce waves having, for example, nearly plane characteristics, are less mechanically demanding and fulfill the requirements of many users.

As the person skilled in the art will also appreciate that embodiments shown in the drawings are independent of the generation principle and thus are valid for not only electro-hydraulic shock wave generation but also for, but not limited to, PP/SW generation based on electromagnetic, piezoceramic and ballistic principles. The pressure pulse generators may, in certain embodiments, be equipped with a water cushion that houses water which defines the path of pressure pulse waves that is, through which those waves are transmitted. In a preferred embodiment, a patient is coupled via ultrasound gel or oil to the acoustic exit window (17), which can, for example, be an acoustic transparent membrane, a water cushion, a plastic plate or a metal plate.

These shock wave energy transmissions are effective in stimulating a cellular response and can be accomplished without creating the cavitation bubbles in the tissue of the target site when employed in other than site targeted high energy focused transmissions. This effectively insures the brain tissue does not have to experience the sensation of hemorrhaging so common in the higher energy focused wave forms having a focal point at or within the targeted treatment site. Bleeding internally causes an increase in fluid pressure which can lead to increased brain damage. This can be completely avoided in this treatment protocol.

The fact that some if not all of the dosage can be at a low energy the common problem of localized hemorrhaging is reduced making it more practical to administer multiple dosages of waves from various orientations inside the mouth to further optimize the treatment and cellular stimulation of the target site. Heretofore focused high energy multiple treatments induced pain and discomfort to the patient. The use of low energy focused or un-focused waves at the target site enables multiple sequential treatments.

The treated area can withstand a far greater number of shock waves based on the selected energy level being emitted. For example, at very low energy levels the stimulation exposure can be provided over prolonged periods as much as 20 minutes if so desired. At higher energy levels the treatment duration can be shortened to less than a minute, less than a second if so desired. The limiting factor in the selected treatment dosage is avoidance or minimization of surrounding cell hemorrhaging and other kinds of damage to the surrounding cells or tissue while still providing a stimulating senescent cell activation or a cellular release or activation of proteins such as brain derived neurotropic factor (BDNF) or VEGF and other growth factors while simultaneously germicidally attacking the degenerative tissue or infectious bacteria at the target site.

In the Extracorporeal Shock wave method of treating a patient at a target site on the anatomy. In this invention, the term target site refers to a reflexology location for a specific orthopedic bone structure, nerve, gland and the tissue of the hand or foot at the desired reflexology zone or region being in the path of the shock wave applicator. The patient is placed in a convenient orientation to permit the source of the emitted waves to most directly send the waves to the target site to initiate shock wave stimulation of the target area. Assuming the target area is within a projected area of the wave transmission, a single transmission dosage of wave energy may be used. The transmission dosage can be from a few seconds to 20 minutes or more dependent on the condition. Preferably the waves are generated from an unfocused or focused source. The unfocused waves can be divergent or near planar and having a low-pressure amplitude and density in the range of 0.00001 mJ/mm² to 1.0 mJ/mm² or less, most typically below 0.2 mJ/mm². The focused source can use a focused beam of waves or can optionally use a diffusing lens or have a far-sight focus to minimize if not eliminate having the localized focus point within the tissue. Preferably the focused shock waves are used at a similarly effective low energy transmission or alternatively can be at higher energy but wherein the tissue target site is disposed pre-convergence inward of the geometric focal point of the emitted wave transmission. Understanding the higher the energy used, the more sensation of pain the patient may experience.

The frequency of the acoustic shock waves or pressure pulses can also be adjusted for treatment variations. A range of 0.5 Hz to 15 MHz can be used for various cell treatment protocols. A more preferred range would be 70 to 150 Hz.

These shock wave energy transmissions are effective in stimulating a cellular response and in some cases, such as unfocused low energy, and even low energy focused emissions can be accomplished without creating the localized hemorrhaging caused by rupturing cavitation bubbles in the tissue of the target site. This effectively insures the patient does not have to experience the sensation of pain so common in the higher energy focused wave forms having a focal point at or within the targeted treatment site. Higher energy acoustic shock waves or pressure pulses including focused ways can be used if the patient is adequately sedated such as during a surgical preparation or even during a surgical procedure.

If the target site is within the body it may be such that the patient or the generating source must be reoriented relative to the site and a second, third or more treatment dosage can be administered. The fact that the dosage is at a low energy the common problem of localized hemorrhaging is reduced making it more practical to administer multiple dosages of waves from various orientations to further optimize the treatment and cellular stimulation of the target site. Heretofore focused high energy multiple treatments induced pain and discomfort to the patient. The use of low energy focused or un-focused waves at the target site enables multiple sequential treatments. Alternatively, the wave source generators may be deployed in an array wherein the subject patient is effectively enveloped or surrounded by a plurality of low energy wave source generators which can be simultaneously bombarding the target site from multiple directions.

The goal in such treatments is to provide 100 to 3000 acoustic shock waves or pressure pulses at a voltage of 14 kV to 28 kV across a spark gap generator in a single treatment preferably or one or more adjuvant treatments by targeting the site impinging the emitted waves on the desired reflexology target.

The underlying principle of these shock wave therapy methods is to stimulate the body's own natural healing capability through the reflexology zone. This is accomplished by deploying shock waves to stimulate cells in the tissue to activate a variety of responses. The acoustic shock waves or pressure pulses transmit or trigger what appears to be a cellular communication throughout the entire anatomical structure, this activates a generalized cellular response at the treatment site, in particular, but more interestingly a systemic response in areas more removed from the wave form pattern. This is believed to be one of the reasons molecular stimulation can be conducted at threshold energies heretofore believed to be well below those commonly accepted as required. Accordingly, not only can the energy intensity be reduced but also the number of applied shock wave impulses can be lowered from several thousand to as few as one or more pulses and still yield a beneficial stimulating response. This allows acoustic wave therapies to be directed to a specific reflexology zone directed toward, for example, an endocrine gland being treated with confidence the signal will be fed back to the entire system via the pituitary gland (hypophysis). This use of acoustic wave stimulation allows a therapy to be given to modulate and adjust glandular secretions of hormones to be regulated and adjusted to achieve a desired adjustment, for example if too low to increase specific secretions, if too high to lessen these secretions. Most importantly, the modulation of and reduction of pain can be achieved in the bone structure and nerves affected by a medical condition and/or medical procedure.

The biological model motivated the design of sources with low pressure amplitudes and energy densities. First: spherical waves generated between two tips of an electrode; and second: nearly even waves generated by generated by generalized parabolic reflectors. Third: divergent shock front characteristics are generated by an ellipsoid behind F2. Unfocused sources are preferably designed for extended two dimensional areas/volumes like skin. The unfocused sources can provide a divergent wave pattern or a nearly planar wave pattern and can be used in isolation or in combination with focused wave patterns yielding to an improved therapeutic treatment capability that is non-invasive with few if any disadvantageous contraindications. Alternatively, a focused wave emitting treatment may be used wherein the focal point extends to the desired reflexology zone or site, preferably at or beyond the target reflexology treatment site within or even potentially external to the patient. In any event, the beam of acoustic waves transmitted needs to project in a large enough reflexology zone or area to stimulate or modulate the gland. This results in the reduction of or elimination of a localized intensity zone with associated noticeable pain effect while providing a wide or enlarged treatment volume at a variety of depths more closely associated with high energy focused wave treatment. The utilization of a diffuser type lens or a shifted far-sighted focal point for the ellipsoidal reflector enables the spreading of the wave energy to effectively create a convergent but off target focal point. This insures less tissue trauma while insuring cellular stimulation to enhance the healing process.

This method of treatment has the steps of, locating a reflexology treatment site or zone, generating either focused shock waves or unfocused shock waves, of directing these shock waves to the treatment site; and applying a sufficient number of these shock waves to induce activation of one or more growth factor thereby inducing or accelerating a modulated adjustment to achieve a proper regulated glandular, muscular, bone or nerve response or in this case, reversing senescence in otherwise dormant cells.

The unfocused shock waves can be of a divergent wave pattern or near planar pattern preferably of a low peak pressure amplitude and density. Typically, the energy density values range as low as 0.000001 mJ/mm² and having a high end energy density of below 1.0 mJ/mm², preferably 0.40 mJ/mm² or less, more preferably 0.20 mJ/mm² or less. The peak pressure amplitude of the positive part of the cycle should be above 1.0 and its duration is below 1-3 microseconds.

The treatment depth can vary from the surface to the full depth of the human or animal torso and the treatment site can be defined by a much larger treatment area than the 0.10-3.0 cm² commonly produced by focused waves. The above methodology is particularly well suited for surface as well as sub-surface soft tissue treatments in a reflexology zone.

An exemplary treatment protocol could have emitted shock waves in a broad range of 0.01 mJ/mm² to 3.0 mJ/mm² and 200-2500 pulses per treatment with a treatment schedule of 1-3 weekly treatments until symptoms reduce. This can be repeated as symptoms reoccur or continue weekly as a preventative. The post medical treatment is beneficial as a pain suppressor and reduces the need for pain medications and allows less addictive medications to be used to prevent addiction.

The above methodology is valuable in generation of tissue, vascularization and may be used in combination with cell therapies as well as regeneration of tissue and vascularization to reverse the effects of aging.

Reflexology methods of treating both feet and hands to generate total wellness, and more specifically this treatment reduces inflammation systemically. No device can do that. This reduction in systemic inflammation in cells cures all auto immune disorders as well as reversing the effects of senescence in cells.

It will be appreciated that the apparatuses and processes of the present invention can have a variety of embodiments, only a few of which are disclosed herein. It will be apparent to the artisan that other embodiments exist and do not depart from the spirit of the invention. Thus, the described embodiments are illustrative and should not be construed as restrictive.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of treating a reflexology zone to reduce aging using pressure pulses or shock waves comprises the steps of:
placing an applicator head of an acoustic shock wave or pressure pulse generator or source at a reflexology zone;
coupling the applicator head directly or indirectly to an exposed surface of the skin near the reflexology zone; and
activating the generator or source to emit pressure pulses or acoustic shock waves through the skin to the reflexology zone to reduce, reverse or stop cell senescence or aging and apoptosis.

2. The method of claim 1, wherein the pressure pulse being an acoustic pulse which includes several cycles of positive and negative pressure.

3. The method of claim 2, wherein the pressure pulse has an amplitude of the positive part of such a cycle should be above 0.1 MPa and the time duration of the pressure pulse is from below a microsecond to about a second.

4. The method of claim 3, wherein the rise times of the positive part of the first pressure cycle in the range of nanoseconds (ns) up to some milliseconds (ms).

5. The method of claim 4, wherein the acoustic shock waves being very fast pressure pulses having amplitudes above 0.1 MPa and rise times of the amplitude being below 1000 ns.

6. The method of claim 3, wherein the duration of the shock wave is typically below 1-3 microseconds (μs) for the positive part of a cycle and typically above some microseconds for the negative part of a cycle.

7. The method of claim 1, wherein subjecting the reflexology zone to convergent, divergent, planar or near planar acoustic shock waves or pressure pulses in the absence of a focal point impinging the reflexology zone stimulating a cellular response in the absence of creating cavitation bubbles evidenced by not experiencing the sensation of hemorrhaging caused by the emitted waves or pulses in cells wherein the cells are positioned within a path of the emitted shock waves or pressure pulses; and away from any localized geometric focal volume or point of the emitted shock waves wherein the emitted shock waves or pressure pulses either have no geometric focal volume or point or have a focal volume or point ahead of the skin or beyond the skin thereby passing the emitted waves or pulses through the skin while avoiding having any localized focal point within the skin, wherein shortened telomeres at ends of chromosomes are lengthened, thereby regenerating the telomeres reversing senescence in cells.

8. The method of claim 1, wherein the emitted pressure pulses or shock waves are convergent, divergent, planar or near planar and the pressure pulse shock wave generator or source is based on electro-hydraulic, electromagnetic, piezoceramic or ballistic wave generation having an energy density value ranging as low as 0.00001 mJ/mm² to a high end of below 1.0 mJ/mm².

9. The method of claim 8, wherein subjecting the cells directly to the acoustic shock waves having a low energy density of less than 1.0 mJ/mm² per shock wave stimulates said reflexology zone wherein the reflexology zone is positioned directly within a path of the emitted pressure pulses or acoustic shock waves in the absence of any focal point or if a focal point exists, the reflexology zone being treated is positioned away from any focal point.

10. The method of claim 1, wherein the frequency of the emitted pressure pulses or shock waves is in the range of 0.5 Hz to 15 MHz.

11. The method of claim 10, wherein the frequency of the emitted pressure pulses or shock waves has a preferred range of 70 Hz to 150 Hz.

12. The method of claim 1, wherein treating the reflexology zone stimulates by accelerating and increasing cell growth or regeneration or repair.

13. The method of claim 1, wherein the acoustic shock waves or pressure pulses are directed to one or more reflexology zones of the hands, feet or ears to cause a positive biologic response to treat the cells.

14. The method of claim 13, wherein the acoustic shock waves or pressure pulses are directed to an entire surface of one or both hands or feet or ears.

15. The method of claim 14, wherein the shock wave or pressure pulse generator is acoustically coupled to the patient's skin using a coupling gel or liquid.

16. The method of claim 13, wherein the positive biologic response reduces or eliminates systemic or local inflammation and reverses senescence in cells.

17. The method of claim 13, wherein the positive biologic response initiates, activates or recruits cells reversing senescence.

18. The method of claim 17, wherein stimulating the one or more reflexology zones or the one or more reflexology zones and the cells causes a stimulation or modulation of adrenergic receptors α and β and one or more of a release of nitric oxide, secretion of digestive enzymes, inflammation reduction, hormonal regulation and peptide recruitment and activation.

19. The method of claim 18, wherein the stimulating the one or more reflexology zones or the one or more reflexology zones and the cells causes a release of growth factors including, but not limited to VEGF.

20. The method of claim 18, wherein the stimulating the one or more reflexology zones or the one or more reflexology zones and the cells causes new blood vessels to be created increasing vascularization and reversing senescence.

21. The method of claim 13 is repeated one or more times to treat and reverse the senescence condition.

22. The method of claim 13, wherein the emitted acoustic shock waves or pressure pulses are low energy soft waves.

23. The method of claim 22, wherein the low energy soft waves have an energy density in the range of 0.01 mJ/mm² to 1.0 mJ/mm².

24. The method of claim 13, wherein each subjected reflexology zone receives between 100 and 100,000 acoustic shock waves or pressure pulses per therapy session.

25. The method of claim 21, wherein the number of repeated treatments occur on a schedule over a period of one or more weeks, and treatments can be repeated over time as an anti-aging protocol over longer durations of time between repeated treatments.

26. A method of stimulating a cellular substance wherein the cellular substance is a patient having senescent cells or a culture of senescent cells comprises the steps of: treating the cellular substance;
activating an acoustic shock wave generator or source to emit pressure pulses or acoustic shock waves directed toward the substance to impinge the substance with pressure pulses or shock waves having a low energy density in the range of 0.00001 mJ/mm² to 1.0 mJ/mm²; the pressure pulse being an acoustic pulse which includes several cycles of positive and negative pressure, wherein the pressure pulse has an amplitude of the positive part of such a cycle should be above 0.1 MPa and the time duration of the pressure pulse is from below a microsecond to about a second, rise times of the positive part of the first pressure cycle in the range of nano-seconds (ns) up to some milli-seconds (ms), the acoustic shock waves being very fast pressure pulses having amplitudes above 0.1 MPa and rise times of the amplitude being below 100's of ns, the duration of the shock wave is typically below 1-3 micro-seconds (μs) for the positive part of a cycle and typically above some micro-seconds for the negative part of a cycle; and
subjecting the cellular substance to convergent, divergent, planar or near planar acoustic shock waves or pressure pulses in the absence of a focal point impinging the substance stimulating a cellular response in the absence of creating cavitation bubbles evidenced by not experiencing the sensation of cellular hemorrhaging caused by the emitted waves or pulses in the substance wherein the cellular substance is positioned within a path of the emitted shock waves or pressure pulses and away from any localized geometric focal volume or point of the emitted shock waves wherein the emitted shock waves or pressure pulses either have no geometric focal volume or point or have a focal volume or point ahead of the cellular substance or beyond the cellular substance thereby passing the emitted waves through the cellular substance while avoiding having any localized focal point within the cellular substance wherein the emitted pressure pulses or shock waves are convergent, divergent, planar or near planar and the pressure pulse shock wave generator or source is based on electro-hydraulic, electromagnetic, piezoceramic or ballistic wave generation having an energy density value ranging as low as 0.00001 mJ/mm² to a high end of below 1.0 mJ/mm².

27. The method of claim 26, wherein the shock waves stimulate the senescent cells enhancing replication.
